(19) United States
(12) Patent Application Publication
(10) Pub. No.: US 2006/0015527 A1
(43) Pub. Date: Jan. 19, 2006

(54) System and method for transport of objects utilizing LDAP directory structure

(76) Inventor: Pamela Dingle, Calgary (CA)

Correspondence Address: GOWLING LAFLEUR HENDERSON LLP, SUITE 1400, 700 2ND ST. SW, CALGARY, AB, T2P 4V5, CA

(21) Appl. No.: 11/144,673

(22) Filed: Jun. 6, 2005

Related U.S. Application Data
(60) Provisional application No. 60/587,877, filed on Jul. 15, 2004.

(51) Int. Cl. G06F 17/00

(52) U.S. Cl. 707/103 X

(57) ABSTRACT

The invention provides for transferring program elements; such as objects, attributes, data and applications; from a source environment to a receiving environment using an Object Transformer, Environment Configurator, Object Selector, and Object Migrator to identify and implement environment and program element specific relationships in a receiving environment based on current relationships in the source environment and historical transfers to the receiving environment.

Priority is claimed from U.S. Provisional Patent Application No. 60/587,877, filed Jul. 15, 2004, entitled “System And Method For Transport Of Objects Utilizing LDAP Directory Structure”, listing Pamela Dingle as inventor, such Provisional Patent Application incorporated herein by reference.

### FIELD OF THE INVENTION

The present invention relates to the field of computer system implementation, specifically the transfer of program elements between systems.

### BACKGROUND OF THE INVENTION

Light-weight Directory Access Protocol (LDAP) enables applications such as portals, e-mail, messaging, identity and web access management; to store system and environment specific configuration information in directory objects and related attributes. The directory objects and attributes are maintained in a directory server and used to manage the support of the LDAP enabled application configurations. Individuals familiar with the art of managing LDAP enabled applications use the supplied LDAP server proprietary administrative interfaces to manually make changes to the objects and attributes supporting LDAP enabled applications.

LDAP enabled applications are deployed on one or more physical and logical servers, known as environments, which contain servers with unique operating attributes and naming standards that vary between environments. Data, and the storage containers of the data known as objects and attributes, are routinely required to be migrated from one environment (the “source environment”) to another (the “receiving environment”). Objects and attributes, and their data, need to be created in each environment based on strict rules that define how objects relate to one another and how information contained in the objects needs to conform to parameters established for each environment. To minimize the risk of application failure, it is a common practice for objects to be transferred between a number of environments for testing and quality assurance purposes prior to final implementation in an environment. Objects are fully tested in each environment until ready to be migrated to the next environment; with environments typically named as: development, test and production.

LDAP servers maintain objects which are similar in nature to tables within a database management system. These LDAP objects have strict relationships between themselves and other objects within the same LDAP server. The relationships can be thought of as lineage relationships of “father, mother, son, daughter, sibling etc.”. The object relationships can be further defined by the software application or applications that utilise these objects and thus the relationships are not always apparent within the LDAP server itself. Objects, when moved into new environments, need to maintain these “family” relationships, and must be transformed to satisfy the parameters of the receiving environment. Linkages to other objects, file systems, physical location names and similar computer network attributes need to be adjusted or created to support the object's transfer to the receiving environment.

It is in the transformation and migration of the LDAP objects, attributes and data from a source environment to a receiving environment that environment specific objects, attributes and data embedded within directory objects need to be created and transformed to reflect the parameters of the receiving environment. Data is maintained in the directory in directory objects and their associated attributes.

Maintaining relationships between directory objects is required during the transformation and migration process. In LDAP-enabled applications, these relationships are many and complex. The relationships between directory objects in an LDAP server are analogous to the path required to find a file on a file server in a computer system. As an example, a path might support the relationship that inter-referenced spreadsheet files have to one another on a file server. The master spreadsheet that contains cell references (links) to cells contained in other spreadsheets need to have fields that define the paths to linked cells and their files embedded in the spreadsheet. Should a linked file be moved to another location or another server and the master file not updated, then the master file would not be able to present the cell content correctly until the link was updated to reference the related files' new location. In LDAP terms, the spreadsheet files are LDAP objects and the spreadsheet cells are LDAP attributes.

In the past, this problem was solved by LDAP administrators relying on their own knowledge of the relationships of the objects for the LDAP enabled application. LDAP administrators would note differences between objects in the source and receiving environments; and then attempt to recreate the object relationships within the receiving environment using the proprietary LDAP-enabled application's interface. LDAP administrators relied on manual processes to determine LDAP object relationships, define differences between existing objects and offspring objects, create offspring directory objects and manually determine target object relationships to be created or maintained. Objects would be manually changed based on differences between existing directory objects and then edited using text editing tools. This manual process requires a significant amount of time, knowledge of inter-object relationships and object attribute dependencies on a large scale. The process is error prone due to human operator mistakes when creating, editing or changing objects attributes, the data contained by the objects and attributes, and in creating new relationships between objects.

Another solution was to have LDAP administrators use LDAP Data Interchange Format (LDIF) export files in conducting manual searching and replacing of LDAP objects and attributes. LDAP administrators then used a software text editor to perform edits to environment specific data and to create new objects and object attributes. This technique required the administrator to have a thorough knowledge of the proprietary system objects, object relationships and data content. The technique provided little flexibility to handle exceptional cases or other complexity and was prone to human error. The technique was seldom used as few administrators were willing to take on the liability of ensuring all directory object dependencies were maintained during the process.

### SUMMARY OF THE INVENTION

It is an object of the present invention to provide for a faster means of migrating LDAP objects, attributes and data between environments.

It is a further object of the present invention to provide for a less labour intensive means for migrating LDAP objects, attributes and data between a source and receiving environment.

It is a further object of the present invention to provide for a means for migrating LDAP objects, attributes and data between source and receiving environments with less resulting errors than otherwise attained by the prior art.

As used herein, “program elements” refers to data and executable constructs accessed, used or implemented by a computer program and includes but is not limited to objects, attributes, data, directories and applications.

As used herein, “object”, “attribute”, “data”, “directory”, “application”, and their respective plural forms refers to those concepts and constructs known in the art; as they apply to a structured repository of information used in a computing system or network, such as a directory service and its applicable protocols. One example of such a directory service and its applicable protocols includes, but the present invention is not intended to be limited to, LDAP.

The system presented in FIG. 1 is one embodiment of the present invention comprised of the Environment Configurator 100, Object Transformer 120, Object Selector 110, Object Migrator 130 and Object Biographer 140.

Environment Configurator 100 is an apparatus which defines, catalogues and maintains attributes of each environment for use by Object Transformer 120. It maintains the environment profiles, directory server profiles and object definitions. It also maintains the profiles of users who are authorised to use the system. The user profiles define which users have access to the system for each environment and for objects the system acts on.

Object Selector 110 determines the objects to be acted on by Object Transformer 120. Object Selector 110 conducts searches of Object Biographer 140. Object Selector 110 can save search criteria for use and re-use at a future points in time. This search criteria is saved in user profiles linked to users of the system described in Environment Configurator 100. Object Selector 110 makes use of Object Biographer 140 information to ensure point in time lineage information is available to Object Transformer 120.

Object Transformer 120 identifies and defines object lineage and object relationship model for each environment used in the migration process. It uses information stored in Environment Configurator 100 to update environment, global and runtime specific information for the directory object(s) selected for transformation. Object Transformer 120 also identifies and readies related objects for use by Object Migrator 130. Object Transformer 120 uses Object Biographer 140 to provide information required to restore a receiving environment to a state at a previous point in time by providing information on how to restore relationships and eliminate transformed objects from the receiving environment while returning object relationships and attribute values to a supportive state for the previous point in time. This allows a user to undo a particular migration or restore the receiving environment to a pre-transformation and pre-migration state.

Object Migrator 130 relocates the transformed objects and their related parent or sibling objects, as determined by Object Transformer 120, to the receiving environment while maintaining the required relationships between the objects within the object relationship model of the receiving environment. Object Migrator 130 also determines where the new object is to be stored within the directory hierarchy of the receiving environment.

Object Biographer 140 documents the object lineage and off-spring to supply future transformations and migrations with information required to complete their tasks. It also provides the necessary information and process order for undoing past actions applied to an object and thus restoring the receiving environment object family to a pre-transformation and migration state.

The system presented in FIG. 1 eliminates errors in transforming objects into new objects and migrating them to a receiving environment. The modules described provide methods for determining object lineage and an ability to project this lineage into new objects based on the parentage of existing objects. The system significantly reduces errors during the process of transforming existing objects and attributes into new objects based on existing object and attribute relationships by determining correct environment values and by determining related objects for use in the new environment. The system significantly reduces human intervention during the collection, transformation and migration of new objects. This reduction of human intervention prevents the previously discussed errors associated with manually typing and copying data and mistakes associated with improper transformation of object lineage and inter-related relationships. The system provides a documented history of the creation, transformation and removal of objects and attributes related to one another across environments.

### BRIEF DESCRIPTION OF THE FIGURES

FIG. 1 shows one embodiment of the present invention, namely a system for transforming objects and their associated attributes and data from a source environment to a receiving environment;

FIG. 2 shows a schematic representation of Environment Configurator 100;

FIG. 3 shows a schematic representation of Object Transformer 120;

FIG. 4 shows a schematic representation of Ojbect Migrator 130;

FIG. 5 shows a schematic representation of Ojbect Biographer 140;

FIG. 6 shows a schematic representation of Object Selector 110; and

FIG. 7 shows a schematic of an alternate embodiment of the present invention;

### DETAILED DESCRIPTION OF THE INVENTION

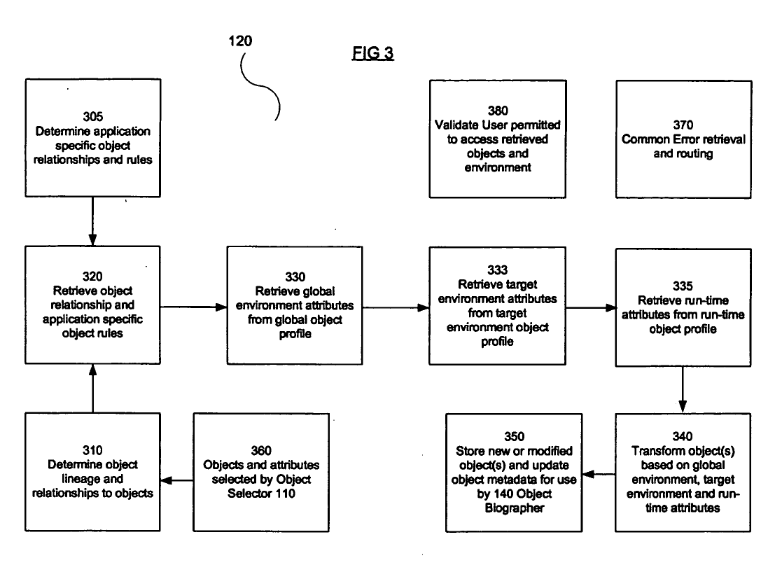

Individuals familiar with crafting software applications will understand that objects and their attributes resident in a source environment will need to be transformed and migrated to a receiving environment based on their relationship(s) to other objects contained within the LDAP server. One means by which this is achieved is by defining the environment(s) that are available to be acted on to the application software using methods set out in FIGS. 2, 3 and 6.

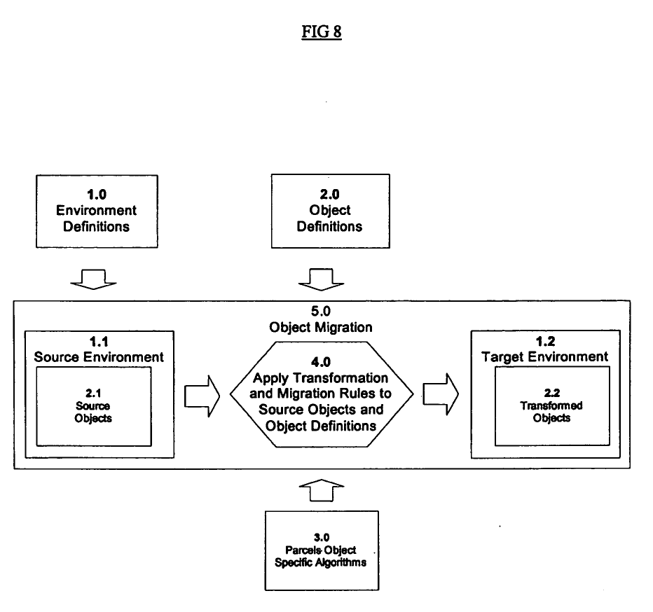

An alternate embodiment of the present invention is described by FIG. 7. The components are further described in detail in the FIGS. 2-6.

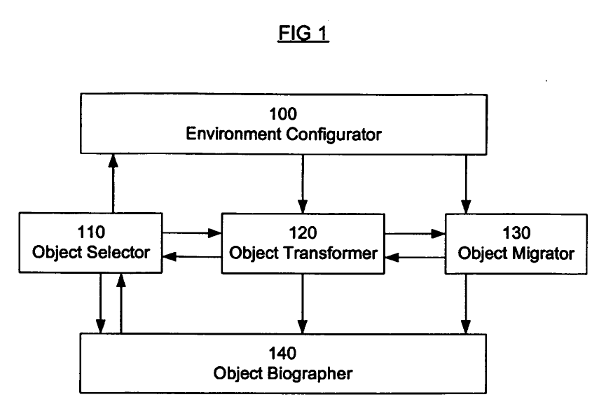

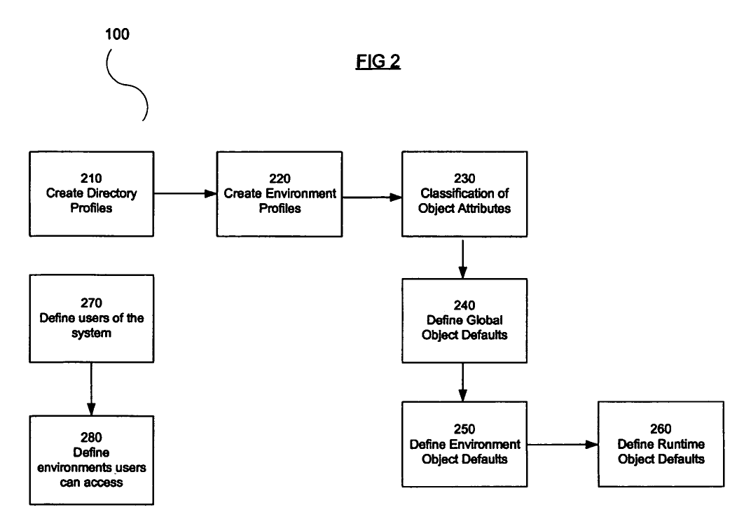

Referring to FIG. 1, a software system diagram is shown for transforming and migrating objects between environments, in particular LDAP objects. The software may be executed via a web-browser or a web-enabled application or software system capable of executing HTML and Java, or application development computer software languages. The invention uses configuration information and object and attribute relationship information stored within a directory that can be either part of, or independent of, the directories to be acted on by the application.

FIG. 1 illustrates the system processes required to create the embodiment of the invention. “Environment Configurator” 100 provides environment profile data to “Object Transformer” 120. Object Transformer 120, uses environment profile data supplied by Environment Configurator 100 and objects to be acted on as supplied by “Object Selector” 110 to create new or cloned objects and attributes based on object lineage relationships as provided by “Object Biographer” 140, for example objects and attributes. Once the object lineage is known and environment profile data processed to determine cross-environment attribute constants, and environment attribute constants and attributes that may be changed at runtime. Thereafter Object Transformer 120 creates new off-spring objects based on the parentage relationships and application specific relationships provided by this data. The new object(s) are then validated to be accurate for use in their targeted environment and migrated to that environment by “Object Migrator” 130.

Referring to FIG. 2, there is an illustration of the processes that comprise the Environment Configurator 100. “Creation of Directory Profiles” 210 is used to define, view, update and delete directories used by directory enabled applications such as e-mail, portals, network security and applications; that use directory data stored in what are known in the art as objects and attributes. Directory servers provide processes for the storage, updating and deleting of objects and attributes used by appropriately enabled systems or applications.

The identified directories are used by the invention for the purpose of performing object creation(s), transformation(s) and migration(s) of objects. Creation of Directory Profile 210 uses existing software techniques for defining unique profiles for each directory. The directory profiles define the technical attributes of each directory such that software is aware of what directory is being acted upon and what its technical characteristics consist of, for use by other processes and methods. This process details such as the following, but is not limited to, port numbers, server definition, Internet Protocol (IP) addresses, access controls available for this directory, and other attributes that commonly define the directory to a software application or system.

Referring to FIG. 2, “Create Environment Profiles” 220 uses existing software techniques to define what physical environments exist for the application to act on and the characteristics of each environment. Environments, which may include, but are not limited to, “development”, versus “quality assurance” or “production”; are defined and managed within this process. These profiles describe the computer file systems, physical characteristics and other attributes of each environment that distinguishes it from others. These profile definitions permit other processes to understand the physical and logical parameters in which the system or application exists and allows the part of the invention described later in 230, 240 and 250 to provide the specific rules related to how objects and attributes are transformed and created.

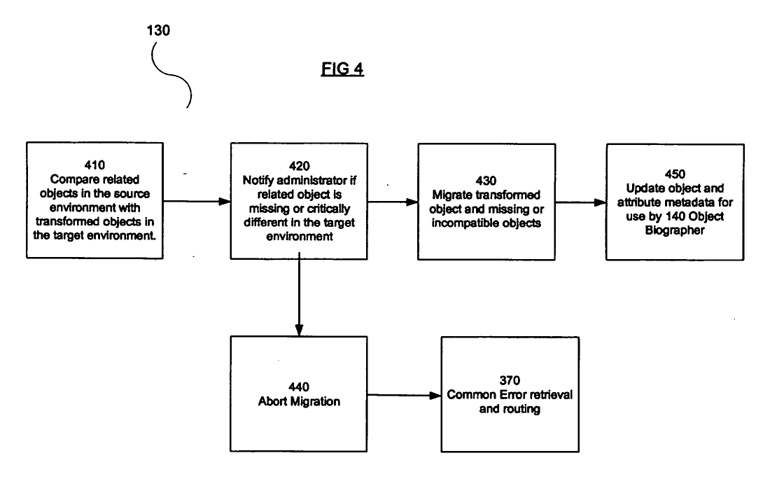

Referring to FIG. 2, “Classification of Object Attributes” 230, describes a novel process used to “bundle” or “parcel” information about existing unique objects and attributes related to specific LDAP dependent applications or systems discussed earlier, that are to be transformed and migrated by Object Transformer 120. Classification of Object Attributes 230 is used to define how objects and attributes are to be acted upon during the transformation process described in FIG. 3. Each object, and associated attributes, used by an application is identified. Objects are classified as “Global Objects” that will have constant values or relationships across all environments; as “Environment Objects” that will have values or relationships in specific environments only, or “Runtime Objects” which will have values or relationships that might be changed by intervention at the point of migration.

Referring to FIG. 2, “Define Global Object Defaults” 240, is used to define the values or templates associated with those object attributes classified as Global Objects, and applied across all environments. Global attributes with constant values to be used during transformation are defined and maintained using Define Global Object Defaults 240. The values are applied by Object Transformer 120 to ensure valid attribute values are applied across all environments.

Referring to FIG. 2, “Define Environment Object Defaults” 250, is used to define values associated with specific supported environments that an object can be transformed to or from. These values and relationships will be applied to the specific environments for which an object is to be created or transformed by Object Transformer 120.

Referring to FIG. 2, Define Runtime Object Defaults 260 is used to define values that can be changed prior to migration. The values associated with the new object or attribute can be changed prior to migration, but if left unchanged are migrated with the selected objects contents to the new environment.

Referring to FIG. 2, “Define Users of the System” 270 uses existing software techniques to establish the identity of people allowed to use the processes. User identity is stored in a directory and is used to provide access to the present transformation system and to determine which objects, attributes and environments a user is permitted access. Process 280 provides a method for defining which users have access to which directories, objects, attributes and environments in the context of performing transformations and migrations.

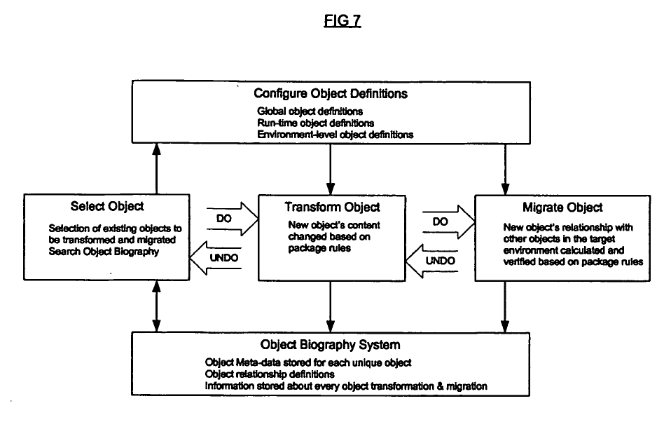

Referring to FIG. 6, Object Selector 110 represents a module that uses existing search and display techniques for determining LDAP Objects that can be acted on by Object Transformer 120. The apparatus consists of processes that provide methods for defining search criteria for selecting one or more objects.

Process 640 is a novel process for the definition of metadata attributes that are used to describe objects and attributes in terms not available in directories. These metadata attributes are used to define object lineage, expanded naming of objects, creation, update and deletion history and application specific use of the objects and attributes. This metadata is used by Process 650. Process 650 allows for the viewing of existing metadata content, updating of the metadata content or deletion of metadata content for any object or attribute with defined metadata attributes created in Process 640. Process 660 stores and indexes each object and attribute metadata and provides definitions and values to the Process 630 which uses this and other data for searching and retrieving objects and or attributes to be used in the process Object Transformer 120.

“Define Search Requirements for Single Object” 610 provides an interface to users of the apparatus to define and execute searches of the directory and of the metadata so that attributes and objects can be retrieved for viewing and selection by the user. The apparatus is used to select which objects will be the source objects and attributes for creation of new or modified objects by Object Transformer 120. Process 630 uses existing search techniques for executing search criteria supplied to it by either Process 610, Process 620, or Process 605. Process 605 can retrieve a predefined search that is supplied by Process 670. Process 670 is used to store predefined searches for repeat use over time. After each search of the directory by Process 630, the requested objects or attributes found by the search process are displayed to the user. The user of the apparatus can then select from a result set of objects and attributes that may contain one or more results that satisfy their search criteria specified in Processes 605, Define Search Requirements for Single Object 610 or 620.

Process 680 permits users of the apparatus to review the objects selected and then mark the objects and or attributes to be acted on by the Object Transformer 120, which is able to then use these objects as the foundation for creating new or cloned object off-spring or siblings for use in the source or receiving environments. Searches and search results that a user wishes to repeat at a later time can be saved in the directory through Process 670.

Referring to FIG. 3, generally referred to as Object Transformer 120, the present transformation system uses Process 310 that determines lineage and relationships of the object(s) provided by, Object Selector 110. Process 310 determines the relationships between objects selected for transformation by referencing the metadata provided by Object Biographer 140.

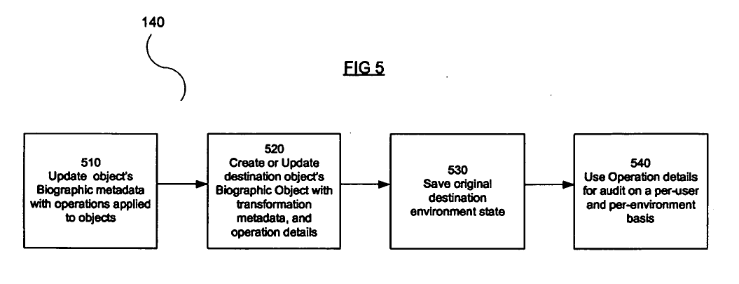

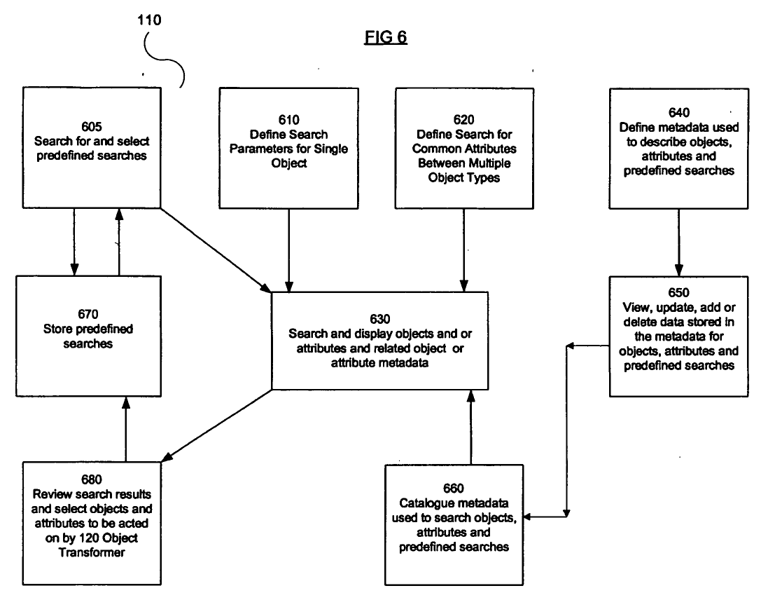

It is known in the art that the relationships of parentage, off-spring, siblings and multiple ancestry levels and application determined and defined relationships are determinants in the creation of new objects that take place in Object Transformer 120. Data stored in metadata fields identifies the current state of object ancestry and is maintained in the Object Biographer 140 referred to in FIG. 5. Referring to FIG. 5, Object Biographer 140 uses sub-processes for documenting transformations, migrations and relationships of objects operated on during the process of Object Transformer 120. Once a new object has been created or modified by Object Transformer 120, Object Biographer 140 uses Process 510 to update or create the biographic profile of the object or objects acted on during the transformation processing. This data is then available to Object Transformer 120, referred to in FIG. 3, and to Object Migrator 130, referred to in FIG. 4.

Referring to FIG. 3, Process 310 provides the rules and relationships for how objects and their attributes relate to one another. Process 320 retrieves application specific rules from Process 305. Process 305 provides a unique set of rules for each application's objects and attributes, called “parcels” of transformation rules, which are used by Process 340. Each parcel is predefined to contain default attribute values, object relationship constraints and pre-packaged software edits and validations that are linked to the creation of the new objects or attributes created by Process 340. The information retrieved by Processes 320, 330, 333 and 335 is used by Process 340 to apply application specific relationship rules required to create new object(s) used by the application, to apply global environment attributes, receiving environment attributes and run-time attribute definitions all of which are established in the Environment Configurator 100.

Relationship rules are interpreted by the transformation Process 340 to create new offspring objects based on the constraints definable by user defined templates or by each application's use of the objects. Based on environment specifications for each attribute of each object, values are constructed to support the receiving environment in relation to the source environment. These values as retrieved by Processes 330 and 333 and set by Process 335 are used to permit the present transformation system to correctly set values based on the receiving environment and to ensure the creation of off-spring objects is performed correctly.

Process 340 is dependent on all the information provided by Processes 320, 330, 333 and 335. The present transformation system uses the lineage of the existing objects and the associated attribute values, the global attribute(s) rules, the target environment attribute(s) rules and runtime attribute value(s) to create new objects and attributes. The transformation from a parent object and its attributes into off-spring or sibling object(s) and attribute(s) relies on the rules retrieved by Processes 320, 330, 333 and 335. These rules are interpreted by the Process 340; which also applies application specific rules as retrieved by Process 320 from Process 305.

Process 350 is used by Process 340 to store the new objects and attributes in the directory for use by Object Migrator 130. Should an object transformation fail, due to missing or invalid rules or other operational errors, then the present system is able to use “Common Error Retrieval and Routing” 370 to retrieve and display the detected error(s) and provide processing options for correcting the error(s). These options can include saving the existing process state and allowing for the updating or changing of environment profile information as described previously.

With reference to FIG. 4, Process 410 of Object Migrator 130 uses application specific edits to validate the object and attributes to be migrated to their new location. Process 410 checks the target environment to ensure that the new object created by Object Transformer 120 is able to be moved into the receiving environment without violation of the target environments constraints. Should the receiving environment be missing, or is critically different from the intended target configuration definition; then Process 420 provides the pre-migration checking and pre-migration status of the objects. If Process 420 determines that the migration process should not be executed, then it provides notification to allow correction of pre-migration conditions through use of the previously described Process 370.

Still with reference to FIG. 4, Process 430 of Object Migrator 130 completes the moving of the new objects and associated attributes and any additional objects required to support the move of the new object into the receiving environment using existing object transferral techniques. Process 430 is capable of requesting additional processing from the application that might be required to support processing by an external application. The request to the application is made based on the application rules retrieved in Process 320 of Object Transformer 120. Upon successful migration to the receiving environment, the object metadata for the receiving environment is updated by Process 450 for use by Object Biographer 140.

What is claimed is:

1. A system for transferring program elements from a source environment to a receiving environment comprising:
an Object Transformer (120);
an Environment Configurator (100);
an Object Selector (110);
an Object Biographer (140); and
an Object Migrator (130);
wherein
said Environment Configurator (100) determines and supplies environmental profile data of the receiving environment to Object Transformer (120);
a user identifies program elements to be transferred to the receiving environment through Object Selector (110);
Object Selector (110) provides the user-identified program elements to be transferred to Object Transformer (120); and
Object Biographer (140) stores and provides Object Transformer (120) program element relationships for a given receiving environment;
whereby
Object Transformer (120) uses environmental profile data, from Environment Configurator (100); user identified program elements to be transferred from Object Selector (110); and program element relationships from Object Biographer (140); to create new program elements in a receiving environment based on the program elements relationships, which are verified as accurate and operable and transferred to the receiving environment by Object Migrator (130).
